(19) United States
(12) Patent Application Publication
(10) Pub. No.: US 2010/0177129 A1
(43) Pub. Date: Jul. 15, 2010

(54) ARTIFACT REDUCTION IN OPTICAL SCANNING DISPLAYS

(76) Inventors: John R. Fredlund, Rochester, NY (US); John A. Agostinelli, Rochester, NY (US)

Correspondence Address: J. Lanny Tucker;Patent Legal Staff, Eastman Kodak Company, 343 State Street, Rochester, NY, 14650-2201, US

(21) Appl. No.: 12/352,073

(22) Filed: Jan. 12, 2009

(51) Int. Cl. G09G 5/10

(52) U.S. Cl. 345/691

(57) ABSTRACT

When producing an image in an optical scanning device, such as an optical scanning device employing pulse width modulation, for example, a pixel or its adjacent pixels are illuminated over a period at least as a function of a sequence of illumination data. Such pixel or its adjacent pixels are illuminated, however, at different locations within the pixel or its adjacent pixels over the period. This varying of the illumination-location within pixels over time reduces the “screen-door effect” present in conventional displays.

### CROSS-REFERENCE TO RELATED APPLICATIONS

This application is related to U.S. patent application Ser. No. ______, filed concurrently herewith, titled “Improved Edge Reproduction in Optical Scanning Displays,” by Fredlund and Agostinelli, and having an attorney docket number of 95433, the entire disclosure of which is hereby incorporated herein by reference. This application also is related to U.S. patent application Ser. No. 12/212,785, filed Sep. 18, 2008, and titled, “Pulse Width Modulation Display Pixels with Spatial Manipulation,” by Fredlund and Agostinelli.

### FIELD OF THE INVENTION

Exemplary embodiments of the present invention are directed to display devices, and in particular, to spatial manipulation of display pixels in such devices.

### BACKGROUND OF THE INVENTION

Image and video reproduction typically involves receiving image or video data and providing a corresponding output image comprising a plurality of display pixels. A variety of display technologies are known, including cathode ray tube (CRT), liquid crystal display (LCD), plasma, digital light processing (DLP), grating electro mechanical system (GEMS), grating light valve (GLV) and the like.

A display system that employs GEMS devices uses a linear array of GEMS devices to modulate incident light to produce a line of pixels. A galvanometer (also referred to as a scanning mirror) sweeps the line image across a screen to form a two-dimensional image. FIG. 1A illustrates an exemplary portion of an image output by a GEMS display system and FIG. 1B illustrates an exemplary input waveform that directs modulation of lasers to generate display pixels in a GEMS display system. A GEMS display system employs pulse width modulation (PWM) signals to direct modulation of one or more lasers to generate the display pixels, where the width of the pulse determines the resulting pixel brightness. A color GEMS display system employs a red, green and blue laser, each of which diffract off of a GEMS device to form an image. Conventionally, as disclosed in U.S. Pat. No. 7,148,910 to Stauffer et al and in U.S. Pat. No. 6,621,615 to Kruschwitz et al, the light pulses generated using pulse-width modulation of the GEMS device result in display pixels that are each centered on the line of display pixels. Thus, as illustrated in FIGS. 1A and 1B, a blue laser is directed by a GEMS device with a voltage corresponding to a high state during the first three modulation windows to produce blue pixels in the first three display columns, and a red laser is directed by a GEMS device with a voltage corresponding to a high state during the third through fifth modulation windows to produce red pixels in the third through fifth display columns. As illustrated in FIGS. 1A and 1B, the pulses are centered within the modulation window, and this produces pixels centered within a display column.

### SUMMARY

It has been recognized that image quality of images produced by conventional display systems using one dimensional light valve arrays together with one dimensional scanners, can be improved by spatial manipulation of display pixels. For instance, it has been recognized that conventional displays can produce display pixels having less than 100% illumination fill-factor in both the scan direction and non-scan direction. These illumination gaps in two dimensions can cause a “screen door” artifact, as shown in FIG. 17a. On the other hand, some conventional optical scanning display systems employ one dimensional modulator arrays, such as the GEMS arrays, which are characterized by completely contiguous screen pixels in the array (non-scan) direction. However, such displays exhibit illumination gaps between pixels in the scan direction, as illustrated by FIG. 17b. These illumination gaps are a consequence of a varying modulation pulse-width, which is a function of pixel brightness and leads to varying pixel-widths in the scan direction. Consequently, pixels having low brightness, and therefore having short pixel-widths, can cause particularly strong artifacts in scanning systems employing pulse-width modulation. Some embodiments of the present invention address these problems at least by illuminating, in an optical scanning display, such as those employing pulse width modulation, a different location within each display pixel for each image frame. Such varying of illumination location within each pixel prevents display-wide pixel illumination gaps from forming a pattern and, consequently, helps to reduce or eliminate pixel fill-factor artifacts.

In some embodiments, the varying of illumination location within a pixel is made to be perceivably random. In laser projection devices, perceived randomness in the variations in pixel-illumination locations reduces speckle, a distracting interference pattern present when lasers interfere in a consistent manner. Such perceived randomness can be generated on a pixel-by-pixel basis, where the illumination location for each pixel is randomly or pseudo-randomly generated independently of the other pixels and independently of prior frames. Or, such perceived randomness can be generated with some dependence on other pixels or prior frames.

It has also been recognized that conventional displays have difficulty reproducing high-contrast edges in a quality manner. For example, high-contrast edges in conventional displays can appear to have jagged, stepped patterns or can lack color fidelity. Some embodiments of the present invention address this problem at least by illuminating, within a pixel through which an edge passes, an off-centered location towards the lighter illumination side of the edge. Such a technique reproduces an edge that is color-accurate with reduced jagging and stepping and with reduced color artifacts over conventional techniques, such as conventional sub-pixel rendering techniques.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIGS. 1A and 1B respectively illustrate a set of display pixels and voltage waveforms that direct modulation of lasers to generate the display pixels in a conventional system;

FIGS. 2A-5B illustrate a set of display pixels and voltage waveforms that direct modulation of lasers to generate the display pixels in accordance with exemplary embodiments of the present invention;

FIG. 6 is a block diagram of an exemplary projection display device in accordance with the present invention;

FIG. 7 is a flow diagram of an exemplary method in accordance with embodiments of the present invention;

FIG. 8 is a flow diagram of another exemplary method in accordance with embodiments of the present invention;

FIGS. 9A and 9B respectively illustrate a set of display pixels and voltage waveforms that direct modulation of lasers to generate the display pixels in a conventional system;

FIGS. 10A and 10B illustrate a set of display pixels and voltage waveforms that direct modulation of lasers to generate the display pixels in accordance with exemplary embodiments of the present invention;

FIGS. 11A and 11B respectively illustrate a set of display pixels and voltage waveforms that direct modulation of lasers to generate the display pixels in a conventional system;

FIGS. 12A-13B illustrate a set of display pixels and voltage waveforms that direct modulation of lasers to generate the display pixels in accordance with exemplary embodiments of the present invention;

FIGS. 14A-16F illustrate a set of display pixels and voltage waveforms that direct modulation of lasers to generate varying illumination-locations within display pixels, in accordance with exemplary embodiments of the present invention;

FIG. 17a illustrates a “screen-door effect” commonly noticeable in conventional displays;

FIG. 17b illustrates a “fill-factor image artifact” commonly noticeable in conventional scanning displays employing pulse-width modulation;

FIGS. 18-21b illustrate conventional techniques for edge reproduction;

FIG. 22 illustrates a technique for edge reproduction, in accordance with exemplary embodiments of the present invention;

FIGS. 23A-25B illustrate a set of display pixels and voltage waveforms that direct modulation of lasers to reproduce an edge, in accordance with exemplary embodiments of the present invention; and

FIGS. 26A-27B illustrate a set of display pixels and voltage waveforms that direct modulation of lasers to reproduce an edge, in accordance with the conventional technique illustrated in FIG. 21b.

It is to be understood that the attached drawings are for purposes of illustrating the concepts of the invention and may not be to scale.

### DETAILED DESCRIPTION

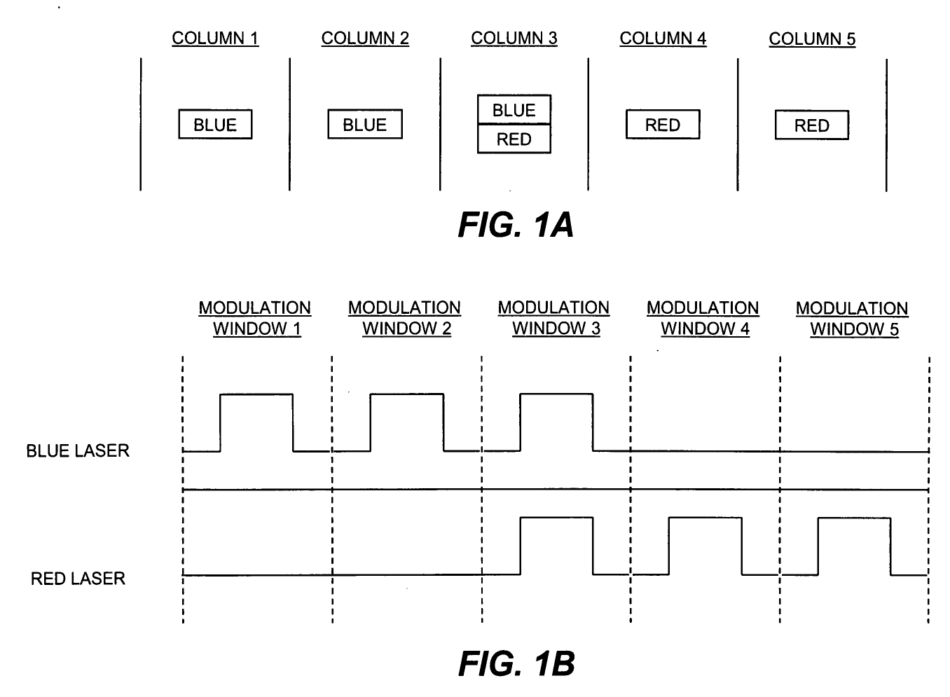

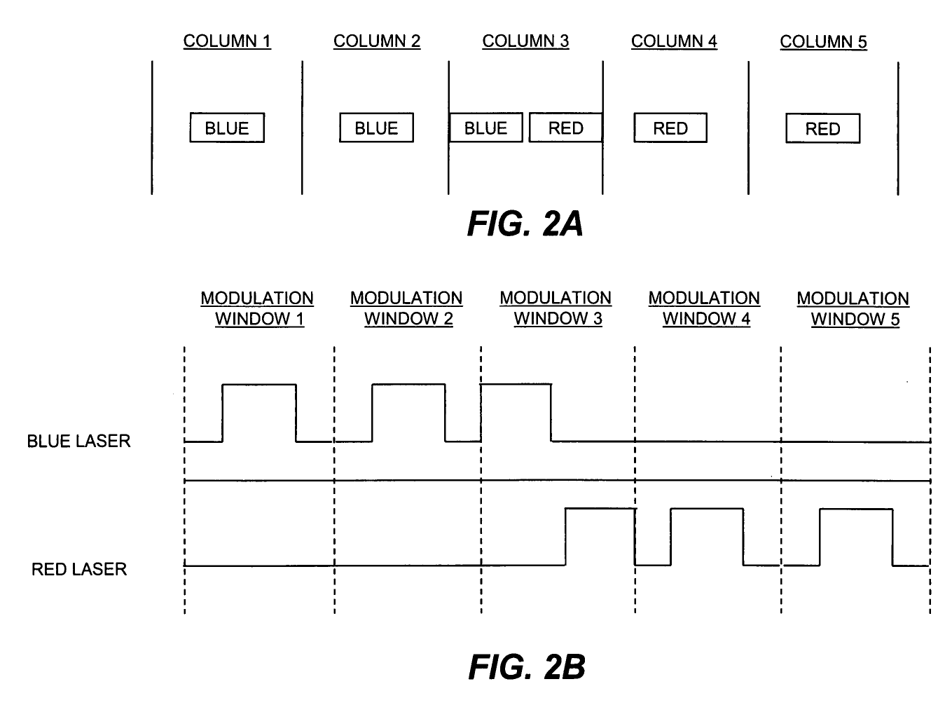

FIGS. 2A-5B illustrate exemplary spatial manipulation of pixels in accordance with embodiments of the present invention. These figures assume that the input image data is the same that is used in FIGS. 1A and 1B. A detector is used to determine a transition exceeding some predefined threshold such as that described by William K. Pratt in Digital Image Processing, pp. 491-556. The detector may be implemented in hardware or software. As illustrated in FIG. 2A, the center of the blue pixel in the third display column can be shifted to the left and the center of the red pixel in the third display column can be shifted to the right. Thus, as illustrated in FIG. 2B, this is achieved by shifting the center of the pulse that directs the modulated blue laser light towards the preceding modulation window and shifting the center of the pulse that directs the modulated red laser light towards the subsequent modulation window. Although exemplary embodiments are disclosed in connection with the use of lasers as a light source, any light source that can be both pulse width modulated and spatially scanned can be used to practice the invention

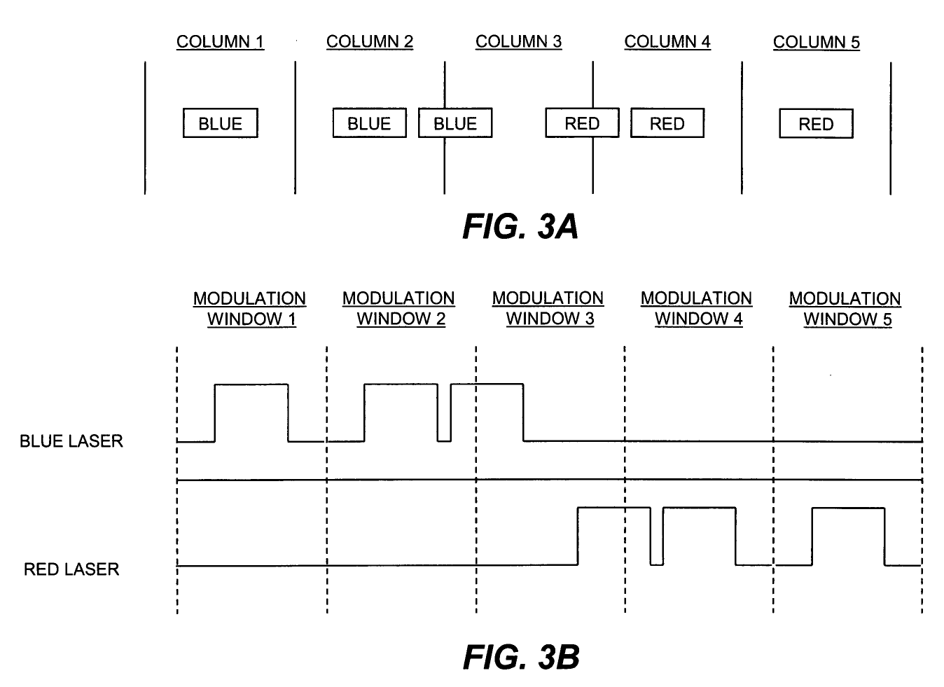

FIGS. 3A and 3B are similar to that of FIGS. 2A and 2B except that the pixels are shifted into an adjacent display column. Thus, as illustrated in FIG. 3B, the center of the pulse that directs the modulation of the blue laser is shifted such that a portion of the pulse occurs in the previous modulation window, and the center of the pulse that directs the modulation of the red laser is shifted such that a portion of the pulse occurs in the subsequent modulation window.

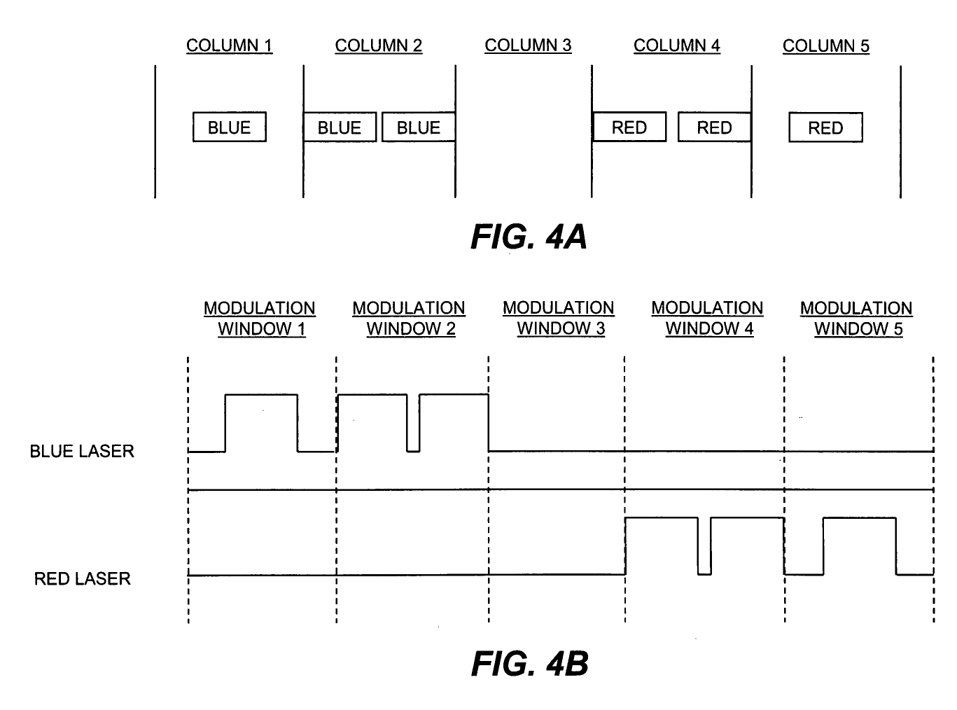

In FIGS. 4A and 4B, the blue and red pixels, which in FIG. 1A are reproduced in the third display column, are shifted entirely into an adjacent column. Thus, as illustrated in FIG. 4B, the blue pulse originally produced in the third modulation window is shifted entirely into the second modulation window, and the blue pulse that was centered in the second modulation window is shifted towards the previous modulation window, while still providing some spatial separation from the pulse shifted from the third modulation window. This spatial separation is described by way of example and is not necessary in practice. Additionally, the blue display pixel that was previously centered within display column 2 has its center shifted towards display column 1, and the red pixel that was previously centered within display column 4 has its center shifted towards display column 5.

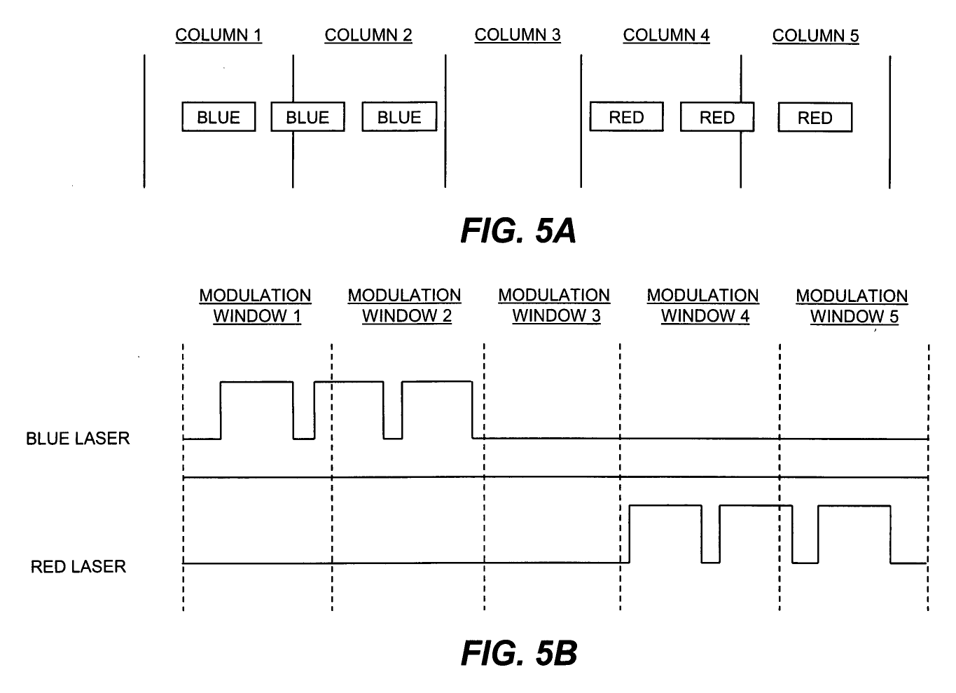

FIGS. 5A and 5B are similar to that of FIGS. 4A and 4B except that the pixels in display columns 2 and 5 that were shifted due to the shift of pixels from display column 3, are shifted into the previous display column (for the blue pixel) and into the subsequent display column (for the red pixel). Accordingly, the corresponding pulses are shifted into the previous modulation window (for the pulse that directs the modulation of the blue laser) and into the subsequent modulation window (for the pulse that directs modulation of the red laser).

It should be recognized that the particular shifting of pixels and pulses are merely exemplary and that other types of shifts can be employed. Furthermore, although the examples above are described only in connection with red and blue lasers, the present invention is equally applicable to any laser color that is employed in a display system. Single lasers or combinations of lasers may be manipulated in the manner described by the invention.

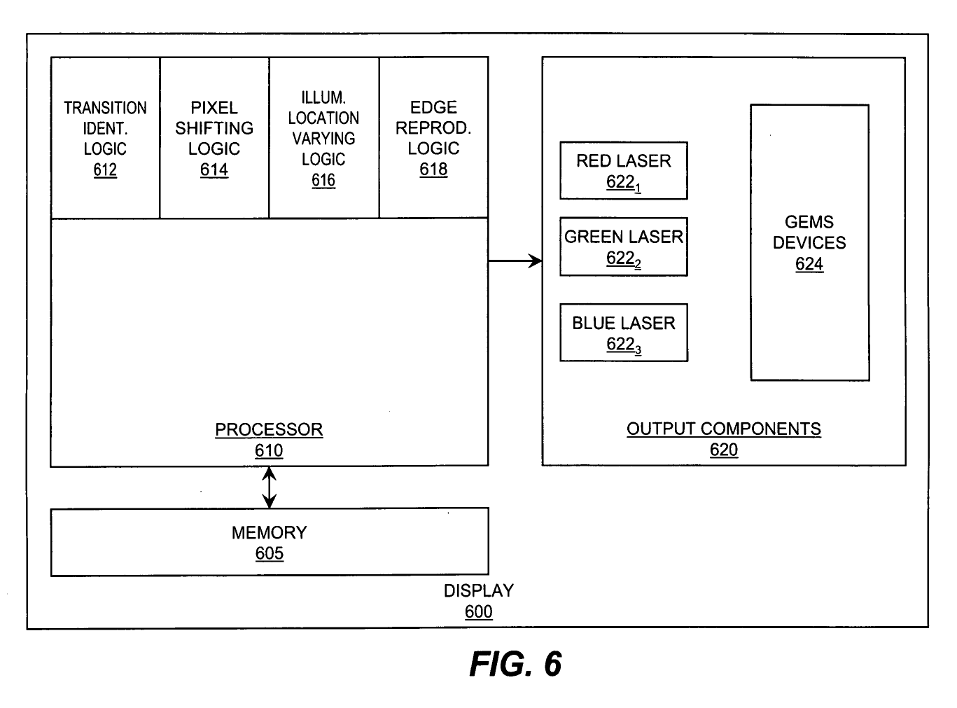

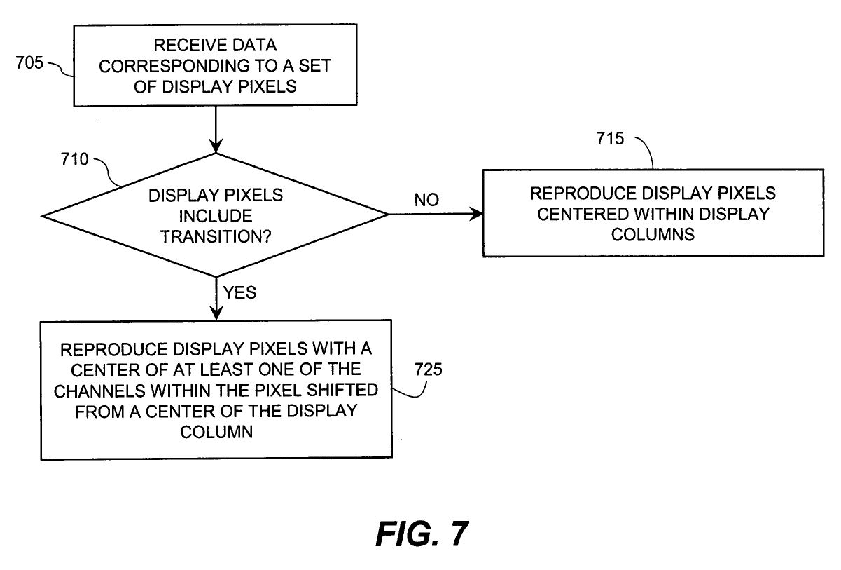

FIG. 6 is a block diagram of an exemplary projection display device in accordance with embodiments of the present invention. Projection display device 600 includes processor 610 coupled to memory 605 and output components 620. Processor 610 includes logic 612, 614, 616, 618, which will be described in more detail below in connection at least with FIGS. 7, 8, 14-16, and 22-25B. Processor 610 can be any type of processor, such as a microprocessor, field programmable gate array (FPGA) and/or an application specific integrated circuit (ASIC). When processor 610 is a microprocessor then logic 612, 614, 616, 618 can be computer-executable code loaded from memory 605 or any other type of computer-readable media. Output components 620 includes red laser 622₁, green laser 622₂ and blue laser 622₃, as well as GEMS devices 624. It will be recognized that FIG. 6 is a simplified diagram of a display device, and the display device can include other components, such as mirrors, lenses, galvanometers, a display screen, additional processors, additional memories, inputs, outputs, etc. Moreover, the output components can include more or fewer lasers, different colored lasers and/or any light source that can be both pulse width modulated and spatially scanned.

FIG. 7 is a flow diagram of an exemplary method in accordance with embodiments of the present invention. Initially, processor 610 receives a set of data corresponding to a set of display pixels (step 705). Logic 612 then determines whether the display pixels include a transition (step 710). The detection of a transition can employ any type of edge detection or color transition technique, which can employ all color channels and/or a single luminance channel. For example, the values in a color channel can be monitored, and a transition is detected when the change of value from one pixel to the next is greater than a threshold value. This threshold can be employed on a per pixel basis or can be a gradient across a number of pixels. In addition to, or as an alternative to, a transition analysis based on pixels within the same horizontal line can involve pixels in adjacent horizontal lines, i.e., a vertical component.

The term “channel” is used to denote a particular color of light. Although exemplary embodiments are described in connection with any given pixel being composed of two or three channels of light (red, green and blue), the present invention is not limited to these channels and can be practiced with channels of any number or wavelength. From the perspective of the output display screen, in a pulse width modulation system, each channel is on for a specified fraction of the total time allotted for each pixel. The specified fraction can be zero.

When the display pixels do not include a transition, (“No” path out of decision step 710), then processor 610 controls output components to reproduce the display pixels such that the display pixels are centered within the display columns (step 715).

Whereas in conventional systems the amount of time any channel is on for a given pixel is centered in the space allotted for that pixel, embodiments of the present invention move the centering of the on time for each pixel in accordance with the pulse width of the channel off center towards adjacent or nearly adjacent pixels. Accordingly, when logic 612 determines that the display pixels include a transition in a channel in step 710, then logic 614 controls output components 620 such that the display pixels are reproduced with the center of at least one display pixel being shifted from a center of the display column (step 725).

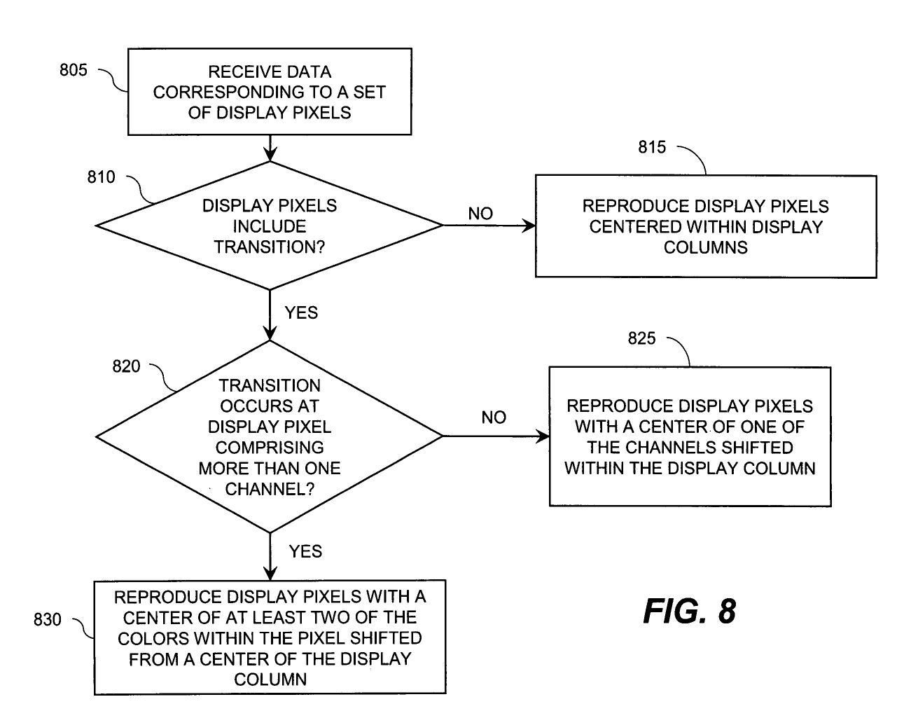

FIG. 7 represents a condition where only a single color channel is determined to have a transition, which is uncommon. Accordingly, the method of FIG. 8 addresses transitions in more than one color channel. As shown in FIG. 8, when logic 612 determines that the display pixels include a transition (“Yes” path out of decision step 810), then logic 612 determines whether the transition occurs at a display pixel that includes more than one channel (step 820). When the transition occurs at a display pixel that includes more than one channel (“Yes” path out of decision step 820), then logic 614 controls output components 620 such that the display pixels are reproduced with the center of at least two of the channels within a display pixel being shifted from a center of the display column (step 830). When the transition occurs at a display pixel that includes only one color (“No” path out of decision step 820), then logic 614 controls output components 620 such that the display pixels are reproduced with a center of at least one of the display pixels being shifted within the display column (step 825). The spatial manipulation of display pixels in steps 825 and 830 can involve any of the spatial manipulation techniques described above.

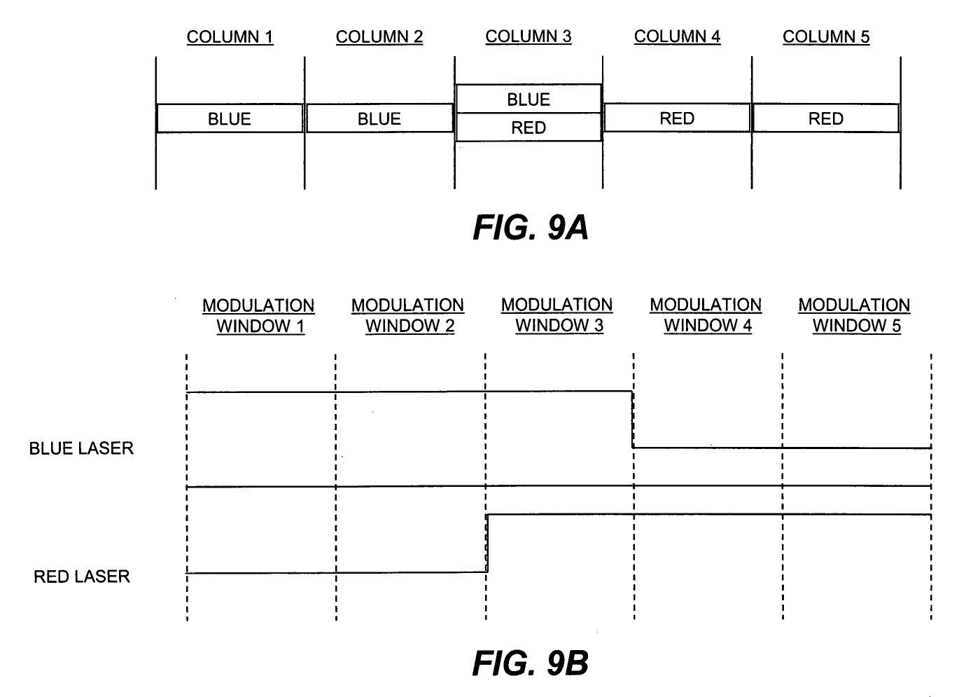

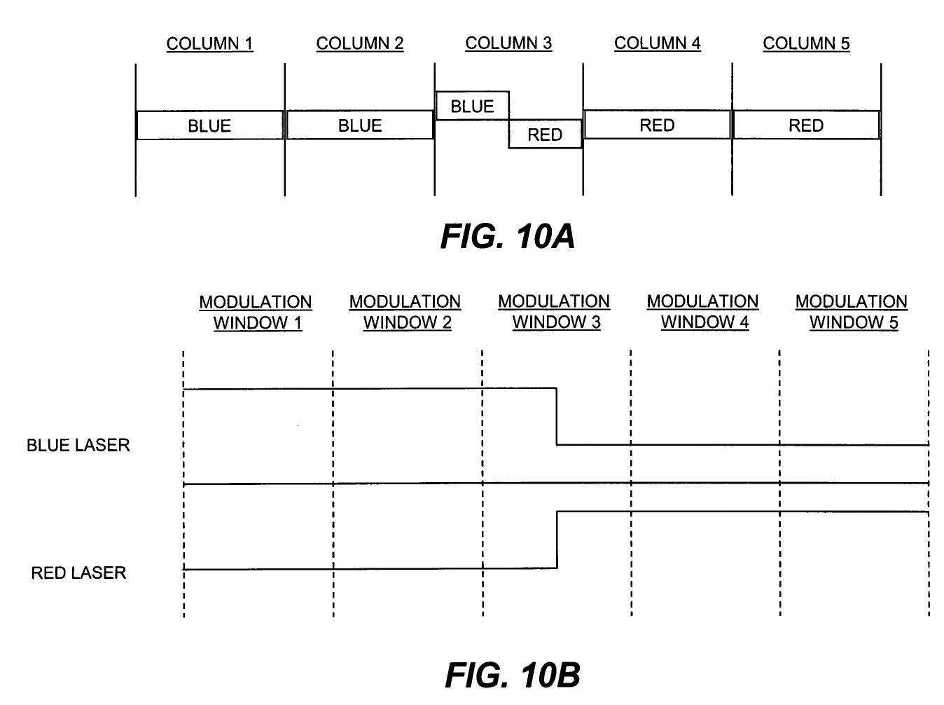

It should be recognized that in certain situations the above-described embodiments may require further refinement. For example, as illustrated in FIGS. 9A and 9B, the center of the blue pixel in the third display column cannot be shifted to the left and the center of the red pixel in the third display column cannot be shifted to the right because both channels are on for the entire modulation window for display column 3. Additionally, the adjacent pixels toward which the center of the pixels in display column 3 would be shifted are on for the entire modulation window. Thus, an additional refinement of the invention is shown in FIGS. 10A and 10B. In this case, the duration of the pulse width for each of the channels in display column 3 is reduced. The on time for the blue channel has been reduced to 50% and the on time for the red channel has been reduced to 50%. This allows movement of the center of the pixel in the manner described above. Specifically, the center of the blue pixel is moved toward the adjacent blue pixel in display column 2, and the center of the red pixel is moved toward the adjacent red pixel in display column 4. While this implementation has been described for two channels, it can also be practiced with a single channel or more than two channels.

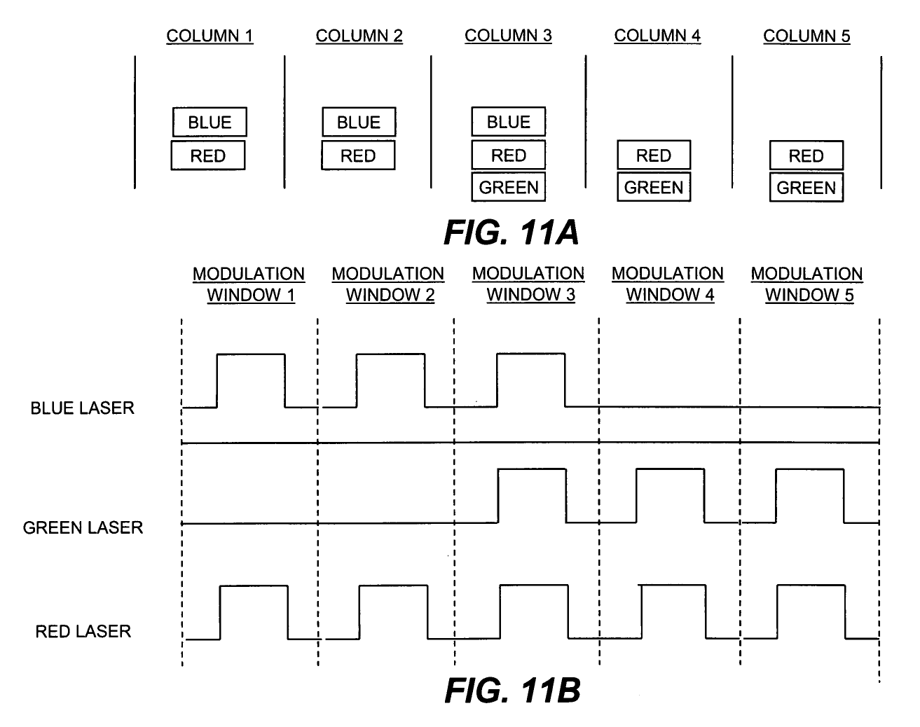

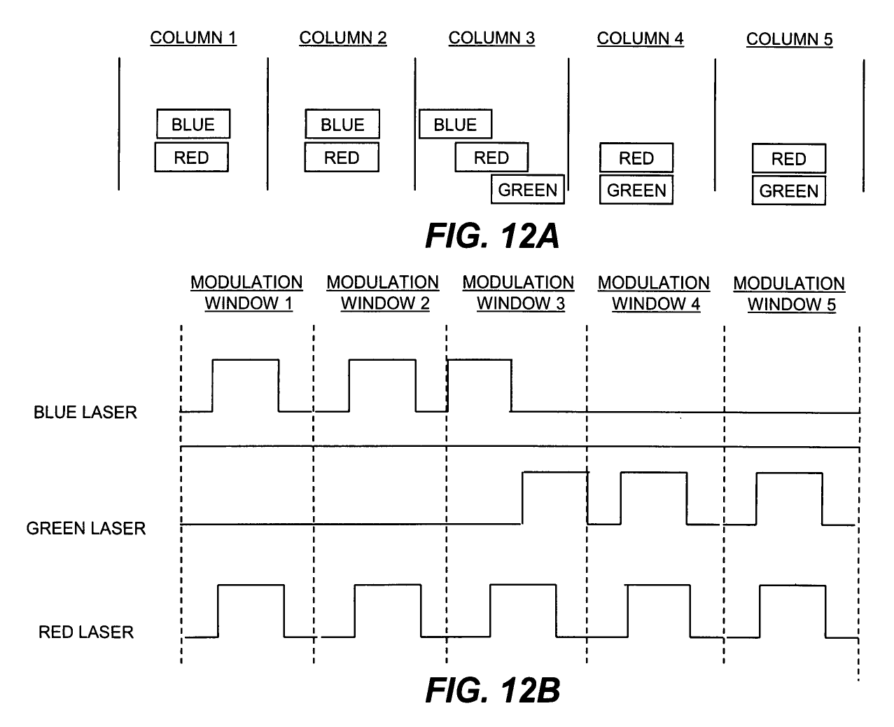

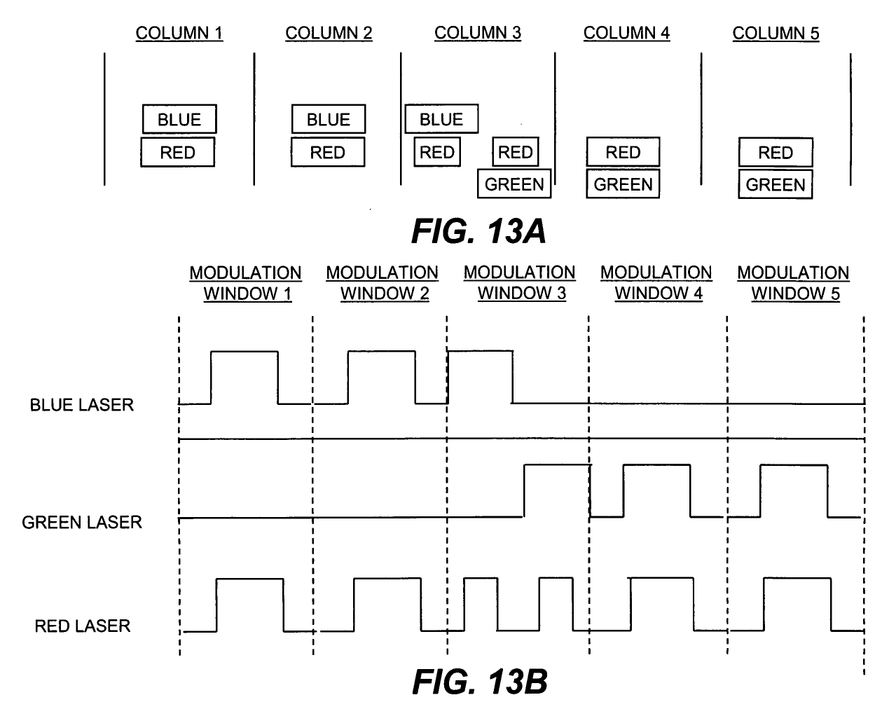

FIGS. 11A and 11B illustrate an example of a prior art transition where more than two channels are involved. In this case, the transition is from purple (red and blue) to yellow (red and green). FIGS. 12A and 12B illustrate an embodiment of the invention where the blue and green pixels have been shifted in display column 3. Note that the blue and green pixels may be moved beyond column boundaries consistent with the invention as described previously. FIGS. 13A and 13B illustrate an embodiment where transitions in the blue and green channels have effect on the red channel. In this case, the red pixel has been split into two sub pixels that fall within display column 3. For display column 3, the total on time for the red channel has been maintained, but this need not be the case. The duration of the sub pixels and the location of the center of the sub pixel may be altered to preserve color fidelity or enhance the sharpening effect. Note that the sub pixels may be moved beyond column boundaries consistent with embodiments of the invention described previously.

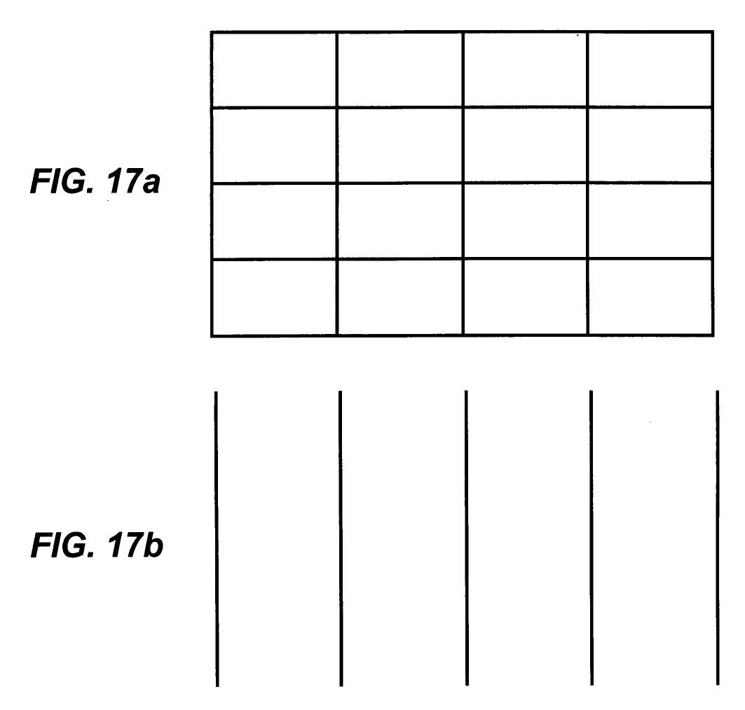

An additional benefit of embodiments of the present invention is the reduction or elimination of fill-factor image artifacts present in conventional displays, which can lessen or remove the visual perception of the locations of the pixels. A version of the fill-factor artifact is the so called “screen door effect” illustrated in FIG. 17a, which is noticeable with conventional displays that use a fixed 2-dimensional array of pixels or otherwise exhibit non-illuminated spaces between pixels that form a grid pattern. This fill-factor image artifact is particularly noticeable upon close inspection of a projected image, or when the magnification of the projected image is large. This effect is accentuated in areas of a projected image such as sky regions where the variation of color and luminance from pixel to adjacent pixel is limited.

Another version of the fill-factor artifact arises in optical scanning displays employing pulse width modulation. These displays employ one dimensional modulator arrays, such as the GEMS arrays, which are characterized by completely contiguous screen pixels in the array (non-scan) direction. That is, a 100% pixel fill factor (i.e., no illumination gap) exists between pixels in the non-scan direction. However, such displays can exhibit, depending upon individual pixel brightness at any point in time, less-than-100% fill factors (i.e., illumination gaps) between pixels in the scan direction. See, for example, FIGS. 1A and 1B, which illustrate a conventional pixel sequence that has illumination gaps between pixels. These illumination gaps are a consequence of a varying modulation pulse-width, which is a function of pixel brightness, which depends upon image content, and leads to varying pixel-widths in the scan direction. Consequently, pixels having low brightness, and therefore having short pixel-widths, can cause particularly strong artifacts in scanning systems employing pulse-width modulation. FIG. 17b illustrates an exaggerated case where all pixels in each pixel column exhibit a same non-maximum illumination level, which would cause the dark stripes shown.

Embodiments of the present invention address these fill-factor artifact problems at least by varying the illumination location within pixels in an image field (also referred to as an image frame) over time in an optical scanning display, such as, for example, a display employing pulse width modulation. Such varying of illumination location within each pixel prevents display-wide pixel illumination gaps from forming a pattern and, consequently, helps to reduce or eliminate fill-factor image artifacts and similar effects relating to gaps in illumination between pixels.

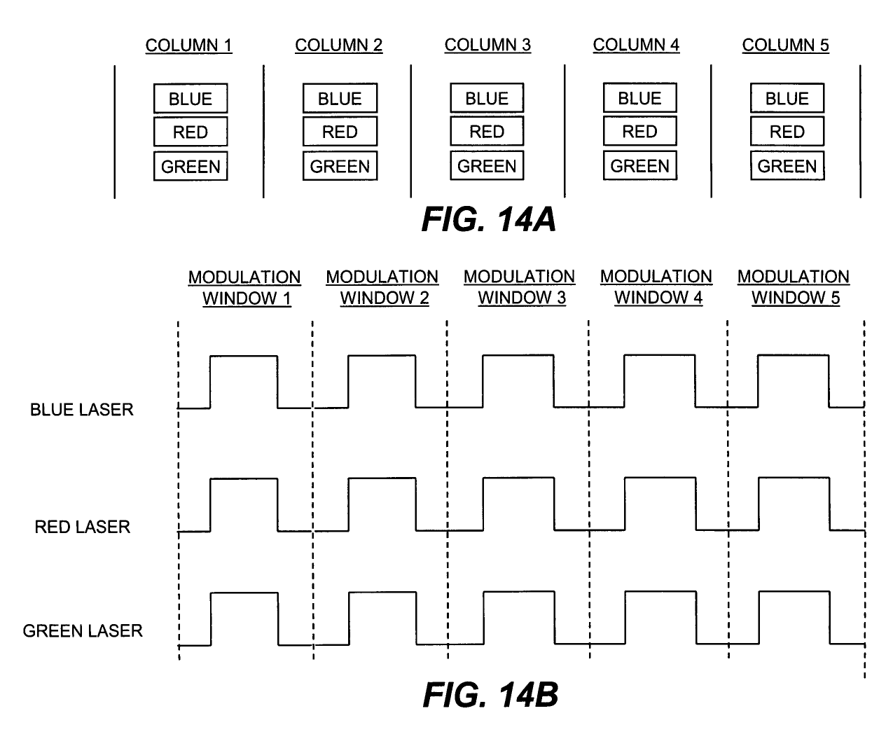

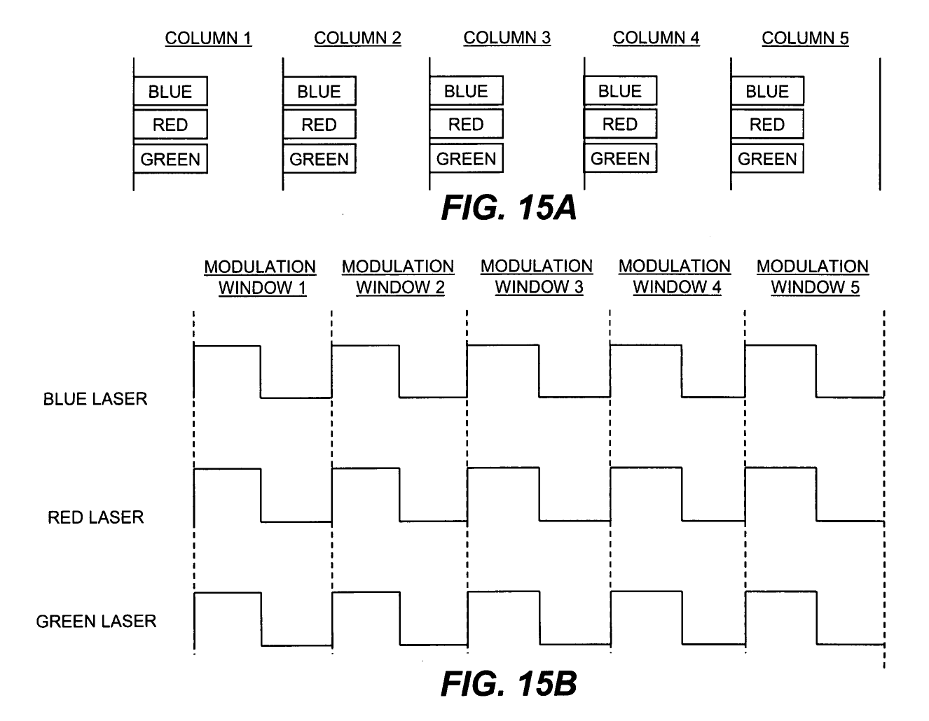

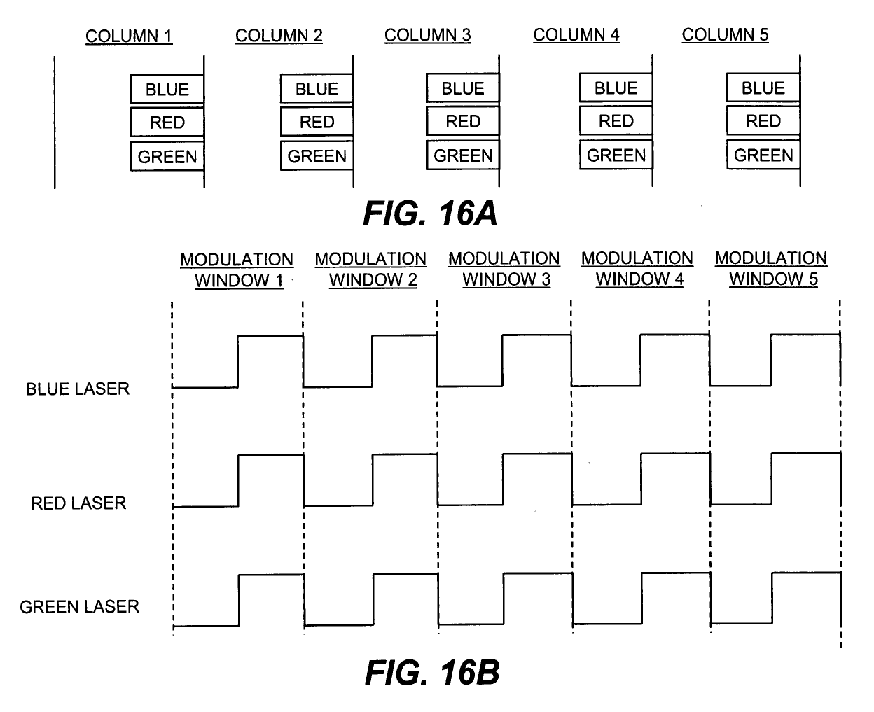

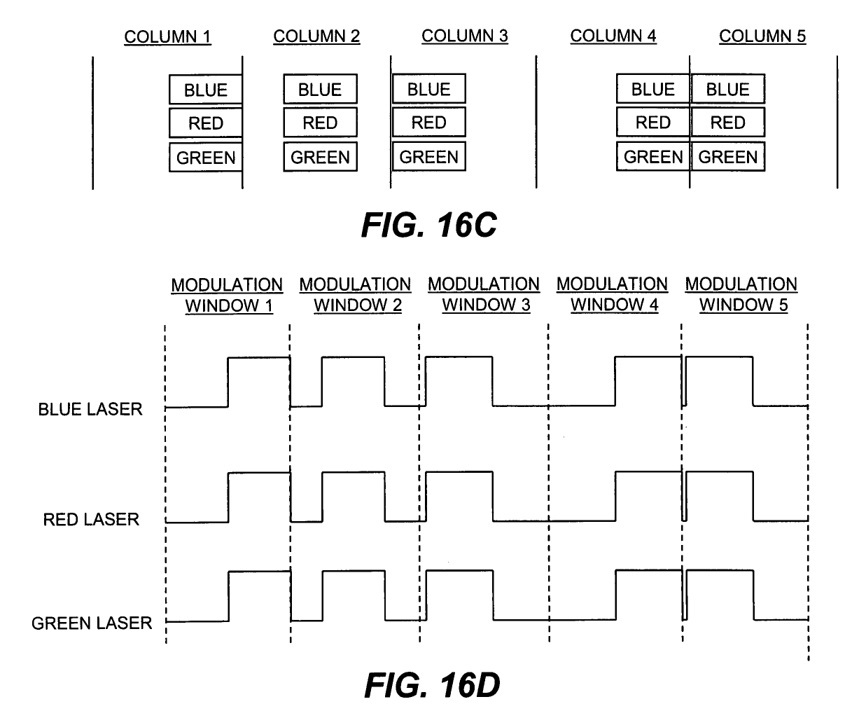

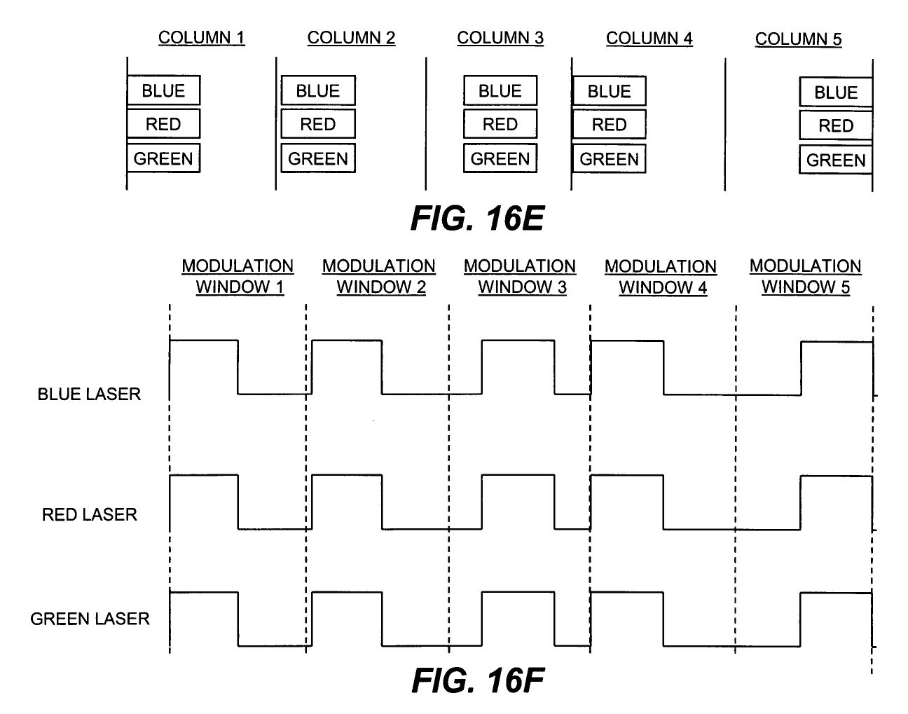

For instance, FIGS. 14A-14B show a series of pixels in a first image field, where each pixel is illuminated for 50% of the available total pulse width in a central pixel illumination location. FIGS. 15A and 15B show a series of pixels in a next, second image field, where each pixel is illuminated for 50% of the available total pulse width, but in a left-most pixel-illumination location. FIGS. 16A and 16B show a series of pixels in a next, third image field, where each pixel is illuminated for 50% of the available total pulse width, but in a right-most pixel-illumination location.

The pixel illumination locations shown in FIGS. 14A and 14B can be used for the nth field. The pixel illumination locations of the pixels shown in FIGS. 15A and 15B can be used for the n+1 field. The pixel illumination locations of the pixels shown in FIGS. 16A and 16B can be used for the n+2 field. The system can recycle, for example, and the n+3 field can be the same as the nth field.

While the examples of FIGS. 14A-16B illustrate a simple technique for varying pixel illumination locations field-to-field to reduce or eliminate the screen-door effect, more complex pixel illumination location sequences or arrangements can be beneficial. For example, it can be beneficial to have a sequence or arrangement of pixel illumination locations that are perceivably random. By perceivably random, it is meant that changes in pixel illumination locations do not produce artifacts distracting to a viewer. In this regard, embodiments such as those illustrated by FIGS. 14A-16B, the arrangement of pixel illumination locations within successive fields can be chosen so that location changes between image fields are perceivably random. Further, more or fewer unique image field arrangements can be used to achieve the desired effect. For example, FIGS. 14A-16B illustrate a case where n−3, but n can be any integer greater than one, depending upon design choice.

Further still, the changes in pixel illumination location can be deterministic or random. To elaborate, FIGS. 14A-16B illustrate the varying of pixel illumination location in a deterministic, but perceivably random manner, according to embodiments of the present invention. In these examples, pixel illumination locations for an entire image field are predetermined, with successive fields having different fixed locations. On the other hand, some embodiments of the present invention vary pixel illumination location in a non-deterministic and perceivably random manner, where each pixel's illumination location is randomly determined independently of other pixels and other fields. In this regard, the perceivably random location of the illumination location for a particular pixel can be independently determined on a pixel-by-pixel basis.

For instance, FIGS. 16C and 16D show a series of pixels in a first image field, where each pixel includes red, green, and blue color channels, and is illuminated for 50% of the available total pulse width in a different perceivably random pixel illumination location from other pixels in the first image field. FIGS. 16E and 16F show the same series of pixels in a next, second image field, where each pixel is illuminated for 50% of the available total pulse width in a different perceivably random pixel illumination location from other pixels in the first and second image fields, thereby illustrating both pixel and image field independence.

Some embodiments of the present invention do not vary pixel illumination location on an entirely predetermined field-by-field basis or on an entirely random pixel-by-pixel basis. Other alternatives exist. For one example, a hybrid field-by-field and pixel-by-pixel approach can be used where a portion of a field has predetermined pixel-illumination locations, and another portion has individual pixels with independently determined pixel-illumination locations. In another example, pixel illumination location can be varied in a column-by-column manner. The pixel illumination locations are varied in the same manner for each column in a field, and these locations are modified so that the pixel illumination locations for each column differ for subsequent fields. The determination of variance can be simplified in this manner.

For yet another example, variation of pixel-illumination location can be dependent, at least in part, on image content. For example, although FIGS. 14A-16F show pixel illumination for 50% of the available total pulse width, any other illumination amount can be used and can be dependent upon image content. In the case of full illumination for the entire available pulse width, change of pixel illumination location may not needed, as the fill-factor image artifact will be reduced or eliminated merely by virtue of the full illumination. Or, the processor 610 can be configured to only vary pixel-illumination for a pixel or group of pixels if any or all of such pixels exhibit an illumination below an illumination threshold. This threshold can be any value. The detection of the illumination threshold can employ any type of threshold detection technique, which can employ all or particular color channels. For instance, in some embodiments, the illumination values in at least one color channel can be monitored, and variation (e.g., non-centering in a perceivably random manner) of pixel-illumination location can be triggered when at least one channel is (at or) below the illumination threshold. Otherwise, if the illumination in each color channel is (at or) above the illumination threshold, pixel-illumination location can be centered.

Accordingly, decisions may be made by the processor 610 that take into account the illumination amounts of pixels. If illumination amounts exceed a threshold, pixel-illumination locations may not change from center. In other words, a pixel is illuminated in a non-centered manner only when corresponding data in a sequence of illumination data indicates an illumination pulse width less than a threshold width. Another approach can be for pixel-illumination location changes from center being inversely proportional to illumination amount. In other words, a degree by which a center of illumination of a pixel departs from a center location in the pixel can be inversely proportional to an illumination pulse width indicated by corresponding data in a sequence of illumination data.

Another example of image-content-dependence is the use of a condition or conditions, such as the detection of a spatially flat field that is not varying quickly with time, to determine whether to cause movement of pixel illumination locations. Stated differently, pixels can be illuminated in a non-centered manner if corresponding data in a sequence of illumination data, e.g., image data, indicates that an image to be represented or a portion thereof is favorable for artifact generation. For example, if a region of an image to be reproduced reveals that a pattern of non-illuminated spaces between pixels (or other artifact) would be displayed, then pixels in that region may have their illumination locations changed in a perceivably random manner.

Having described embodiments pertaining to varying pixel illumination location to reduce or eliminate the fill-factor artifact or similar effects, it should be understood that the invention is not limited to any particular manner in which pixel illumination locations are varied, so long as they are varied in a manner that reduces such effects and, advantageously in certain circumstances, does not produce artifacts distracting to a viewer. For example, varying pixel illumination locations with or without a dependency on image content on a field-by-field basis, on a region-by-region basis, on a column-by-column basis, on a row-by-row basis, on a pixel-by-pixel basis, or combinations thereof are all within the scope of the invention.

In addition, FIGS. 14 through 16 show embodiments where positions of the pulse widths of each of the different color channels associated with a multi-channel pixel have been varied in the same manner. However, it is also possible to vary colors independently to achieve the same effect. For example, each color channel can have a different illumination location within the pixel for a corresponding segment of data in a sequence of illumination data. The illumination location within the pixel for each channel can be varied independently over time such that there will be no perceived loss of color fidelity.

It should be noted that, although FIGS. 14-16 illustrate each pixel being illuminated according to illumination data associated with it, the embodiments of FIGS. 3-5 also may apply, where illumination for a particular pixel is shifted into adjacent pixels.

In view of the above-discussions with respect to FIGS. 14-16, it is instructive to describe how the processor 610 operates via logic 616 with respect to a particular pixel. For example, the processor 610 can receive a sequence of illumination data corresponding to a pixel in a set of display pixels. Such pixel could, for example, be any column 1, 2, 3, 4, or 5 shown in FIGS. 14A-16F. The sequence of illumination data for such pixel could indicate the colors to be represented by such pixel over a period. In the cases of FIGS. 14A-16F, the illumination data for any column would indicate that such pixel should display the color gray throughout the series of image fields represented in these figures. The processor 610 then illuminates the pixel, or adjacent pixels as previously described, over a period at least as a function of the sequence of illumination data. In the case of FIGS. 14A-16F, the processor 610 would cause the pixel to display the color gray in each of the successive image fields shown. Further, the processor 610 illuminates different perceivably random locations within the pixel or adjacent pixels over the period.

As previously described, this illumination of different perceivably random locations may or may not occur as a function of image data, which can be considered to include the sequence of illumination data. Also as previously described, the illumination of differently perceivably random locations of a first pixel may occur independently of another, second pixel, such as the case when pixel illumination locations are independently determined on a pixel-by-pixel basis. Or, it may occur consistently with another, second pixel, such as the case where pixel illumination locations are predetermined for a set of fields, column-by-column, row-by-row, region by region, or it may occur globally, that is, in the same manner for each pixel in the entire image.

In addition to the advantageous effect of reducing fill-factor artifacts, the invention also reduces speckle in laser projection systems. Because the position of the pixels is varied spatially, the portion of the surface upon which a given pixel is projected will be different. Thus, the interference patterns induced are reduced since the additive or subtractive effects of the reflection from the surface will change due to the fact different areas of the surface are illuminated.

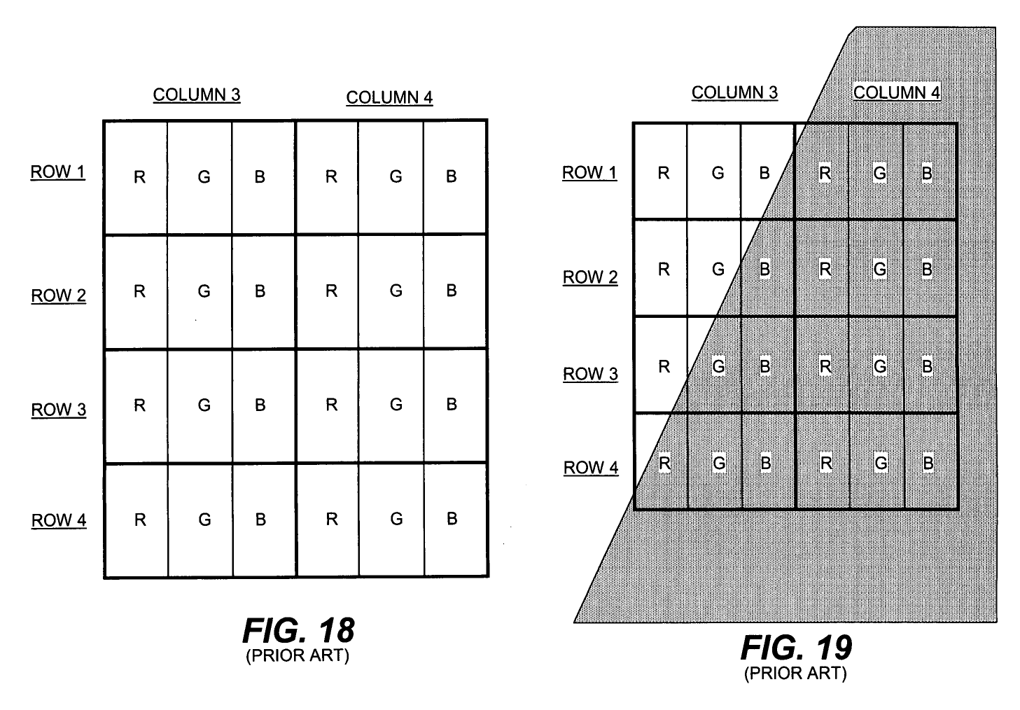

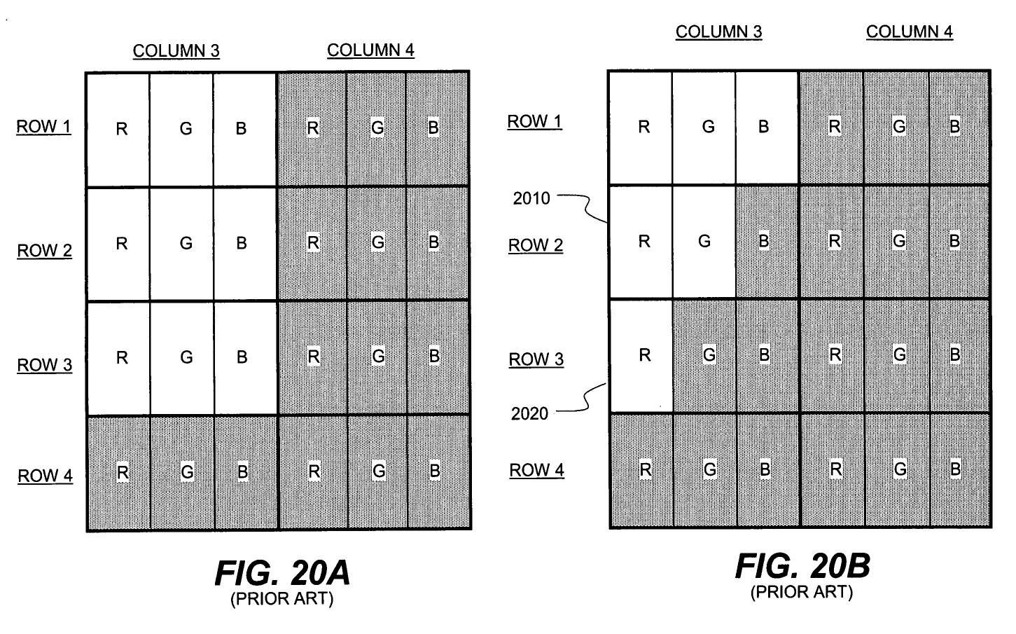

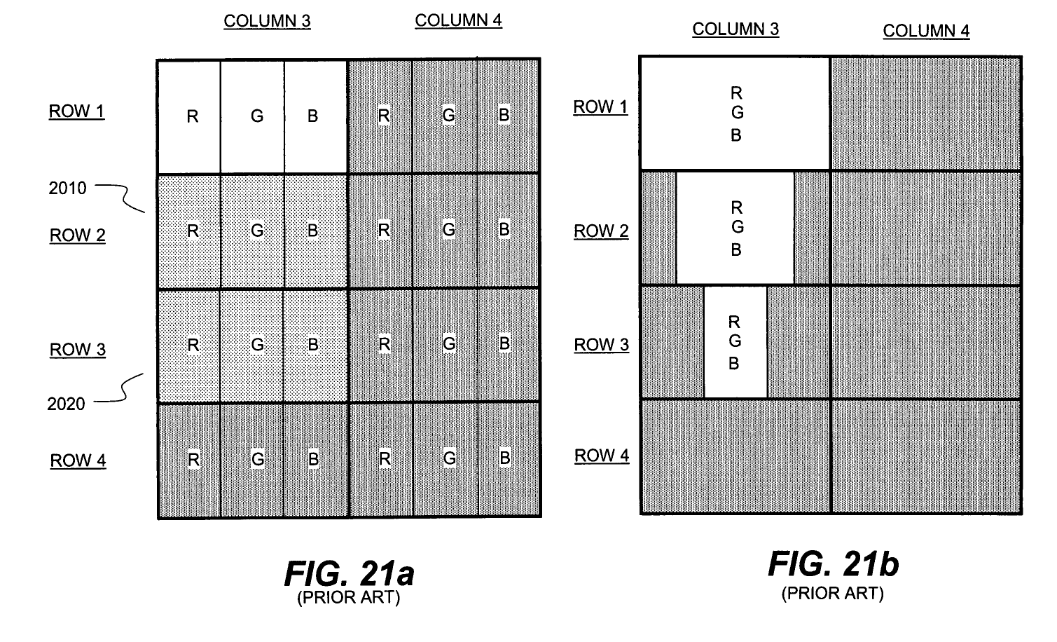

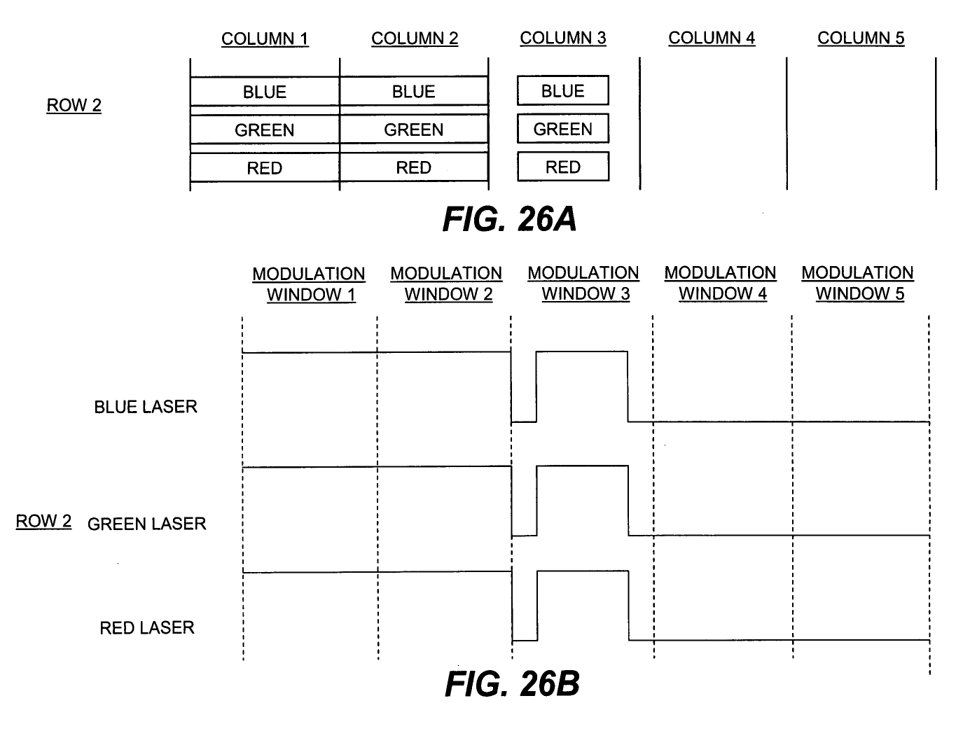

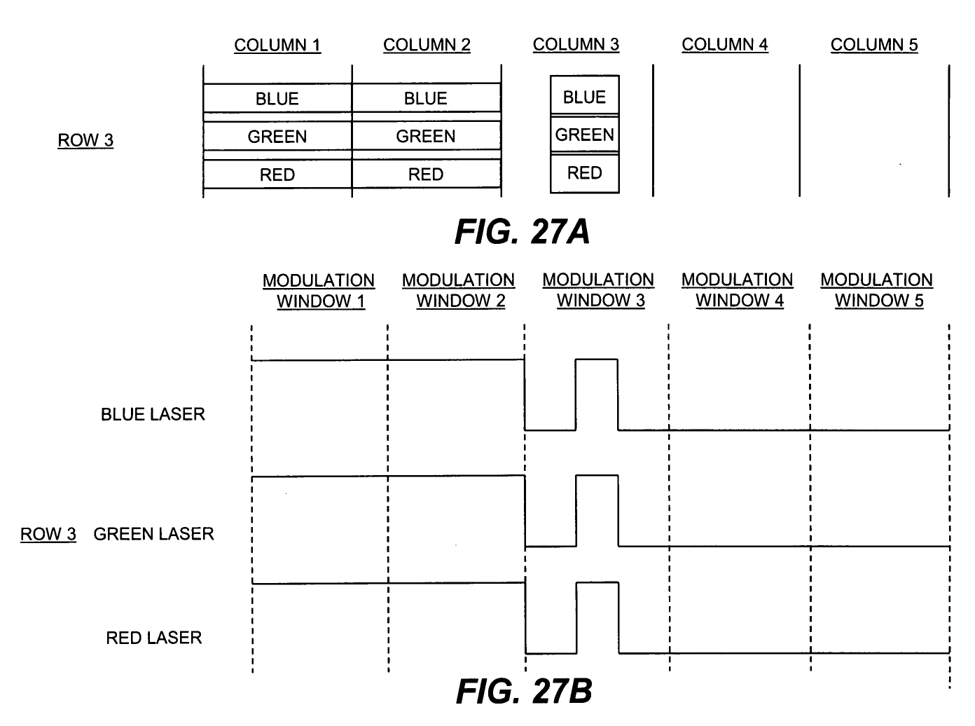

An additional benefit of embodiments of the present invention is improved reproduction of edges and lines represented in image content. It has been recognized that conventional displays have difficult times reproducing high-contrast edges in a quality manner. For example, systems with fixed positioning of color components of pixels as shown in FIG. 18, such as LCD displays or plasma display panels, use sub-pixel rendering to provide the perception of higher resolution when displaying text. For example, FIG. 19 shows an overlay of an arbitrary dark shape, such as the angled side of the capital letter A. The display of FIG. 18 cannot reproduce the angle correctly due to the fact that the transition from white to dark does not occur at macro pixel (R, G and B together) boundaries. FIG. 20A shows how the figure would be displayed conventionally if no sub-pixel rendering is employed. This technique enjoys good white to dark color fidelity, but the errors in spatial rendering introduce “jaggies,” which are perceptible stair steps. FIG. 20B shows a conventional technique that exhibits better luminance rendition through the use of sub-pixel rendering. However, since the bright section of macro pixel 2010 is now illuminated without the blue component, an unwanted yellow coloration is induced. Similarly, the bright section of macro pixel 2020 is now illuminated without the green or blue component, so a different unwanted red coloration is induced. FIG. 21a shows a conventional technique where chrominance is maintained by varying the overall intensity of the macro-pixels 2010 and 2020 in an attempt to approximate the transition and “fool” the perception of the observer. The luminance transition of this technique, however, can still be improved upon. FIG. 21b shows a conventional technique used for non-fixed-position color-component displays where pixel-illumination positioning is centered within a column. FIGS. 26A and 26B illustrate a set of display pixels and voltage waveforms that direct modulation of lasers to reproduce an edge, in accordance with pixel row 2 shown in FIG. 21b. Similarly, FIGS. 27A and 27B illustrate a set of display pixels and voltage waveforms that direct modulation of lasers to reproduce an edge, in accordance with pixel row 3 shown in FIG. 21b. This technique maintains color fidelity, but its luminance transition produces shaded regions on an improper side of the edge.

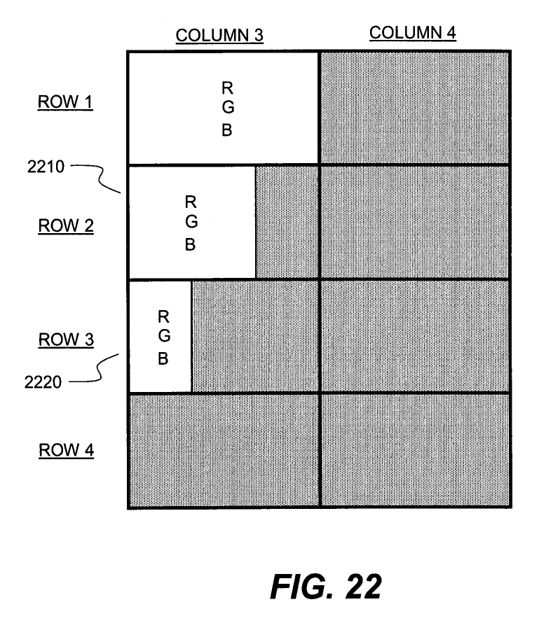

FIG. 22 illustrates a technique for edge reproduction in an optical scanning display, such as a display incorporating pulse-width modulation, in accordance with embodiments of the present invention. In these embodiments, the processor 610 receives image data corresponding to a set of display pixels, such as the eight display pixels shown in FIG. 22. The image data represents an image, such as the portion of black text on a white background shown in FIG. 19. The processor 610 (via logic 618) then determines that a transition occurs within a pixel, such as pixel 2210 in FIG. 22, in the set of display pixels, the transition involving a change from darker to lighter illumination. In this regard, logic 618 can utilize logic 612. In the case of black text on a white background, as represented in FIGS. 19 and 22, the transition from darker to lighter illumination is made by illuminating an off-centered location within the pixel (e.g., pixel 2210) towards the lighter illumination side of the transition, or edge.

In FIG. 22, the transition in the first row is at a pixel boundary and no off-centering of a pixel illumination location is necessary. In the second row, a transition occurs within pixel 2210. Consequently, pixel 2210 has an off-center location within it illuminated toward the lighter side of the transition or edge. A similar off-centering of the pixel illumination location of pixel 2220 occurs. Although the examples of FIGS. 22-25B illustrate a white-to-black transition, any other transition type may occur, with color-accurate reproductions of each side of an edge occurring in the appropriate regions of the pixel. In this regard, a single pixel may have, for example, two illumination regions, one with a lighter illumination than the other. Each illumination region would be off-center within the pixel toward its respective side of the edge.

By illuminating an off-center location within a pixel towards the lighter side of an illumination transition, the pixel is illuminated in a manner more consistent with the edge being reproduced than conventional techniques. Further, because all necessary color channels can be illuminated at the same location(s) within the pixel, color fidelity is maintained. Consequently, the embodiments of the present invention that incorporate the features described with respect to FIGS. 22-25B reproduce edges that are color-accurate with reduced jagging and stepping over conventional devices.

The example of FIG. 22 shows a transition of an edge where a single pixel is divided into two regions: a lighter illumination region and a darker illumination region. The invention, however, is not so limited. Each pixel can be divided into more than two such regions, as would be the case when more than one edge passes through a single pixel.

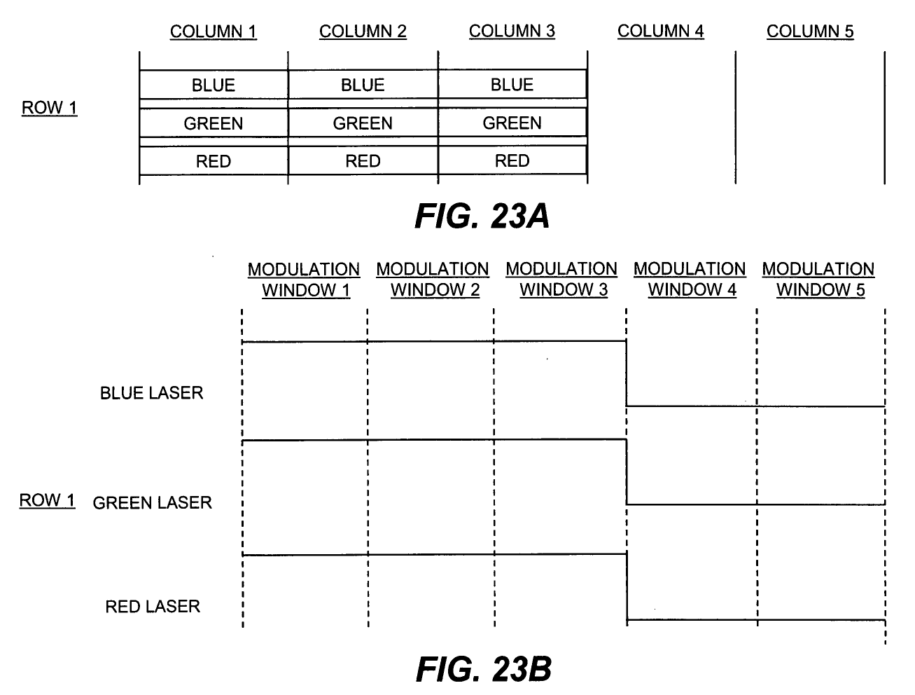

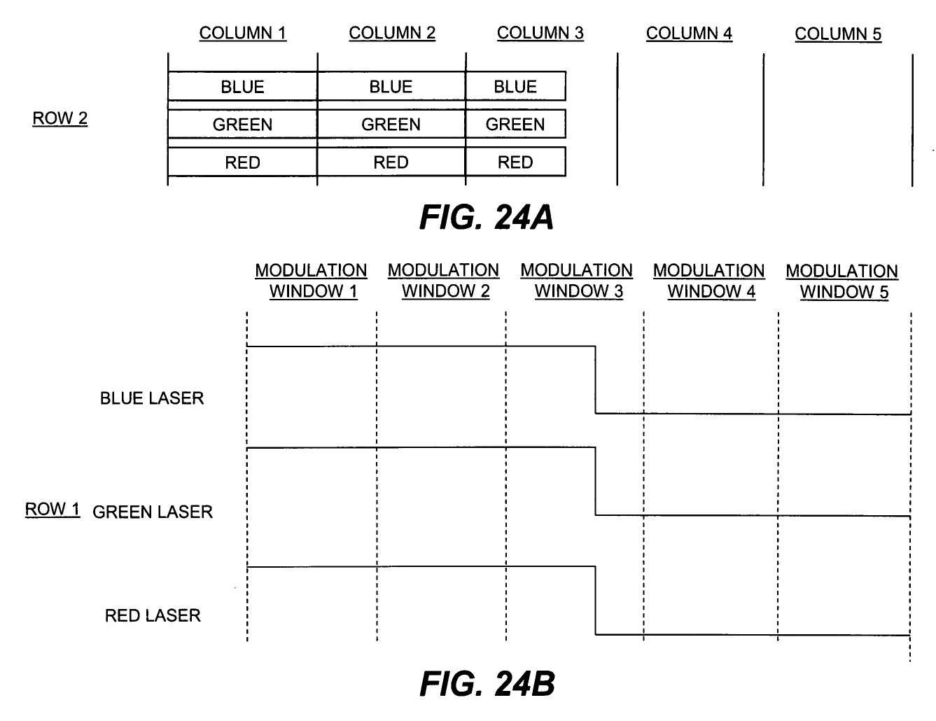

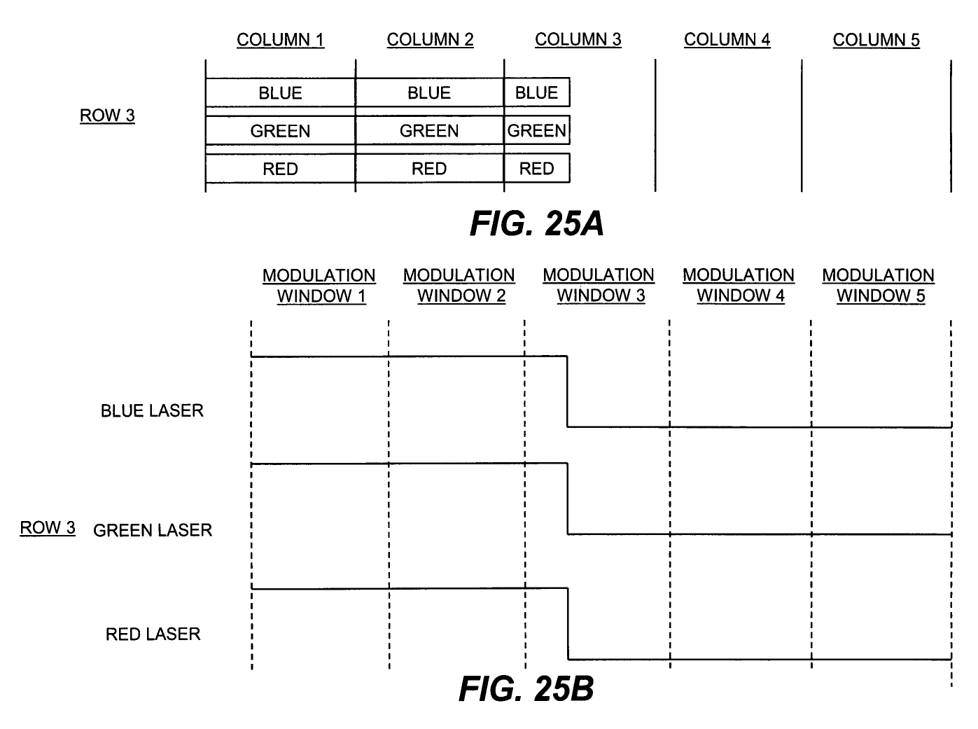

FIGS. 23A and 23B show the condition where the transition from white to dark occurs on a pixel boundary. Here, all three lasers are on for the entire space in Modulation Window 3. FIGS. 24A and 24B show a first condition where the transition from lighter illumination to darker illumination occurs within a pixel. Here, all three lasers are on for two-thirds of the space in Modulation Window 3. Note that the space during which the lasers are on is not centered in Modulation Window 3, but is initiated at the left edge of Modulation Window 3. FIGS. 25A and 25B show a second condition where the transition from lighter illumination to darker illumination occurs within a pixel. Here, all three lasers are on for one-third of the space in Modulation Window 3. Note, once again, that the space during which the lasers are on is not centered in Modulation Window 3, but is initiated at the left edge of Modulation Window 3 in this case.

Although exemplary embodiments have been described in connection with displays that employ GEMS technology, the present invention is equally applicable to other types of optical scanning display technologies that do not employ pulse width modulation, but can benefit from the pixel location or timing control described herein, such as, for example, grating light value (GLV) technology developed by Silicon Light Machines and Sony. Moreover, although exemplary embodiments have been described above in connection with one dimensional scanned imaging systems, exemplary embodiments can also be employed in two-dimensionally scanned imaging systems, for example, laser scanners having 2-axis mirror scanners.

The invention has been described in detail with particular reference to certain preferred embodiments thereof, but it will be understood that variations and modifications can be effected within the scope of the invention.

### Parts List

600 projection display device
605 memory
610 processor
612 logic
614 logic
616 logic
618 logic
620 output components
622₁ red laser
622₂ green laser
622₃ blue laser
624 GEMS Devices
705 step
710 decision step
715 step
725 step
805 step
810 decision step
815 step
820 decision step
825 step
830 step
2010 macro pixel
2020 macro pixel
2210 pixel
2220 pixel

1. A method of producing an image with an optically scanned display, the method comprising:
receiving a sequence of illumination data corresponding to a pixel in a set of display pixels; and
illuminating the pixel or adjacent pixels over a period by optical scanning and at least as a function of the sequence of illumination data, wherein different perceivably random locations within the pixel or adjacent pixels are illuminated over the period.

2. The method of claim 1, wherein the illuminating illuminates the pixel only, not adjacent pixels, over the period.

3. The method of claim 1, wherein the different perceivably random locations are determined as a function of the sequence of illumination data.

4. The method of claim 3, wherein the pixel is illuminated in a non-centered manner if corresponding data in the sequence of illumination data indicates an illumination pulse width less than a threshold width.

5. The method of claim 3, wherein a degree by which a center of illumination of the pixel departs from a center location in the pixel is inversely proportional to an illumination pulse width indicated by corresponding data in the sequence of illumination data.

6. The method of claim 3, wherein the pixel is illuminated in a non-centered manner if corresponding data in the sequence of illumination data indicates that an image to be represented or a portion thereof is favorable for artifact generation.

7. The method of claim 1, wherein the sequence of illumination data is a first sequence of illumination data, the pixel is a first pixel, and the method further comprises:
receiving a second sequence of illumination data corresponding to a second pixel in the set of display pixels; and
illuminating the second pixel or adjacent pixels over the period at least as a function of the second sequence of illumination data,
wherein different perceivably random locations within the second pixel or adjacent pixels are illuminated over the period, and
wherein the different perceivably random locations within the first pixel and the second pixel change perceivably independently of each other.

8. The method of claim 1, wherein the sequence of illumination data is a first sequence of illumination data, the pixel is a first pixel, and the method further comprises:
receiving a second sequence of illumination data corresponding to a second pixel in the set of display pixels; and
illuminating the second pixel or adjacent pixels over the period at least as a function of the second sequence of illumination data,
wherein different perceivably random locations within the second pixel or adjacent pixels are illuminated over the period, and
wherein the different perceivably random locations within the first pixel and the second pixel change consistently with each other.

9. The method of claim 8, wherein the different perceivably random locations are fixed for each of a plurality of image fields displayed in sequence and then repeat upon display of a last of the plurality of image fields.

10. The method of claim 1, wherein the illuminating includes illuminating multiple color channels.

11. The method of claim 10, wherein each color channel has a different illumination location within the pixel for a corresponding segment of data in the sequence of illumination data.

12. The method of claim 10, wherein each of the perceivably different random locations are illuminated during a particular period of the period, and wherein each of the perceivably different random locations include overlapping illumination from all of the multiple color channels being displayed by the pixel during the respective particular period.

13. The method of claim 1, wherein the pixel is illuminated with laser illumination.

14. A system that produces an image with an optically scanned display, the system comprising:
an output component that forms an image comprising a first set of display pixels; and
a processor, coupled to the output component, the processor receiving a sequence of illumination data corresponding to a pixel in a set of display pixels, and the processor comprising logic that causes illumination of the pixel or adjacent pixels over a period by optical scanning and at least as a function of the sequence of illumination data, wherein different perceivably random locations within the pixel or adjacent pixels are illuminated over the period.

15. The system of claim 14, wherein the logic causes illumination of the pixel only, not adjacent pixels, over the period.

16. The system of claim 14, wherein the logic determines the different perceivably random locations as a function of the sequence of illumination data.

17. The system of claim 16, wherein the logic causes the pixel to be illuminated in a non-centered manner if corresponding data in the sequence of illumination data indicates an illumination pulse width less than a threshold width.

18. The system of claim 16, wherein, according to the logic, a degree by which a center of illumination of the pixel departs from a center location in the pixel is inversely proportional to an illumination pulse width indicated by corresponding data in the sequence of illumination data.

19. The system of claim 16, wherein the logic causes the pixel to be illuminated in a non-centered manner if corresponding data in the sequence of illumination data indicates that an image to be represented or a portion thereof is favorable for artifact generation.

20. The system of claim 14, wherein the sequence of illumination data is a first sequence of illumination data, the pixel is a first pixel, the processor receives a second sequence of illumination data corresponding to a second pixel in the set of display pixels, and the processor further comprises:
logic that causes illumination of the second pixel or adjacent pixels over the period at least as a function of the second sequence of illumination data,
wherein different perceivably random locations within the second pixel or adjacent pixels are illuminated over the period, and
wherein the different perceivably random locations within the first pixel and the second pixel change perceivably independently of each other.

21. The system of claim 14, wherein the sequence of illumination data is a first sequence of illumination data, the pixel is a first pixel, the processor receives a second sequence of illumination data corresponding to a second pixel in the set of display pixels, and the processor further comprises:
logic that causes illumination of the second pixel or adjacent pixels over the period at least as a function of the second sequence of illumination data,
wherein different perceivably random locations within the second pixel or adjacent pixels are illuminated over the period, and
wherein the different perceivably random locations within the first pixel and the second pixel change consistently with each other.

22. The system of claim 21, wherein, according to the logic, the different perceivably random locations are fixed for each of a plurality of image fields displayed in sequence and then repeat upon display of a last of the plurality of image fields.

23. The system of claim 14, wherein the logic causes illumination of the pixel in multiple color channels.

24. The system of claim 23, wherein each of the perceivably different random locations are illuminated during a particular period of the period, and wherein each of the perceivably different random locations include overlapping illumination from all of the multiple color channels being displayed by the pixel during the respective particular period.

25. The system of claim 14, wherein the logic causes illumination of the pixel with laser illumination.
